(19) United States
(12) Patent Application Publication
(10) Pub. No.: US 2012/0026147 A1
(43) Pub. Date: Feb. 2, 2012

(54) ORGANIC LIGHT EMITTING DISPLAY

(76) Inventor: Naoaki Komiya, Yongin-city (KR)

(21) Appl. No.: 13/007,589

(22) Filed: Jan. 14, 2011

(30) Foreign Application Priority Data
Jul. 27, 2010 (KR) 10-2010-0072427

(51) Int. Cl. G09G 5/00; G09G 3/30

(52) U.S. Cl. 345/211; 345/76

(57) ABSTRACT

An organic light emitting display includes a display unit including a plurality of pixels coupled to scan lines, first control lines, second control lines, and data lines, a control line driver for providing first and second control signals to the pixels through the first and second control lines, and a timing controller for controlling the control line driver. The timing controller is configured to determine a refresh rate of input data to control points of time at which the first and second control signals are applied in a frame.

### CROSS-REFERENCE TO RELATED APPLICATION

This application claims priority to and the benefit of Korean Patent Application No. 10-2010-0072427, filed on Jul. 27, 2010, in the Korean Intellectual Property Office, the entire content of which is incorporated herein by reference.

### BACKGROUND

1. Field

The present invention relates to an organic light emitting display.

2. Description of the Related Art

Cathode ray tubes (CRTs) have previously been used to display images. However, CRTs can have the disadvantages of being heavy and large in size. Recently, various flat panel displays (FPDs) have been developed that are capable of reducing the heavier weight and larger volume that are the disadvantages of CRTs. Examples of FPDs include liquid crystal displays (LCDs), field emission displays (FEDs), plasma display panels (PDPs), and organic light emitting displays.

Organic light emitting displays can display images using organic light emitting diodes (OLEDs) that generate light by re-combination of electrons and holes. An organic light emitting display can have a high response speed and can be driven with low power consumption.

In general, OLEDs can be divided into two types according to the method of driving the OLED: passive matrix type OLEDs (PMOLEDs) and active matrix type OLEDs (AMOLEDs).

An AMOLED may include a plurality of gate lines, a plurality of data lines, a plurality of power source lines, and a plurality of pixels coupled to the above lines and arranged in the form of a matrix. In addition, each of the pixels commonly includes: an OLED; two transistors, for example, a switching transistor for transmitting a data signal and a driving transistor for driving an electroluminescent (EL) element in accordance with a data signal; and a capacitor for maintaining a data voltage.

An AMOLED generally has low power consumption. However, the magnitude of current that flows through the OLED can vary with variations in the voltage between the gate and source terminals of the driving transistor for driving the OLED. Therefore, variations in the threshold voltages of the driving transistors of OLEDs can cause non-uniformity in the display of images.

It is difficult to manufacture the driving transistors so that the characteristics of all of the driving transistors of the AMOLED are the same. Since the characteristics of the transistors provided in each of the pixels may vary with manufacturing process variables, variations in the threshold voltages of the pixels typically exist.

In order to alleviate such variations in threshold voltages, researches relating to a compensation circuit including a plurality of transistors and capacitors are being performed. The problem of non-uniformity in the display of images may be addressed by further including the compensation circuit in each of the pixels. However, as a result, a large number of transistors and capacitors may be required to be mounted in each of the pixels.

When the compensation circuit is added to each of the pixels, the number of transistors and capacitors that constitute each of the pixels and the number of signal lines for controlling the transistors is increased. Consequently, in the case of a bottom emission type AMOLED, the aperture ratio is reduced, and the possibility of generating defects in the image display increases as the number of components in the circuit increases and the circuit becomes more complicated as a result.

In addition, in order to remove motion blur in display images (e.g., a motion blur phenomenon), high-speed scan driving at a frequency of no less than 120 Hz is typically used. At such frequencies, the charge time for each of the scan lines can be significantly reduced. However, when the compensation circuit is provided in each of the pixels so that a large number of transistors is used in each of the pixels coupled to one scan line, capacitive load increases. As a result, it is difficult to realize high-speed scan driving with such a complex compensation circuit.

### SUMMARY

Accordingly, according to exemplary embodiments of the present invention, an organic light emitting display is capable of selectively realizing a progressive emission method or a concurrent (e.g., simultaneous) emission method in response to a refresh rate of input data to reduce power consumption.

An exemplary embodiment of the present invention provides an organic light emitting display including a display unit which includes a plurality of pixels coupled to scan lines, first control lines, second control lines, and data lines; a control line driver for providing first and second control signals to the pixels through the first and second control lines; and a timing controller for controlling the control line driver,

The timing controller may be configured to determine a refresh rate of input data to control points of time at which the first and second control signals are applied in a frame. When data with a high refresh rate are input, the frame may be temporally separated into a plurality of operation periods. The first and second control signals may be concurrently provided to the pixels in a first period of the frame.

When data with a low refresh rate are input, a plurality of operation periods may be sequentially performed in the scan lines in the frame. The first and second control signals may be sequentially provided to the pixels in the frame.

According to one embodiment of the present invention, each of the pixels includes an organic light emitting diode (OWED) having an anode electrode and a cathode electrode; a first transistor having a gate electrode coupled to one of the scan lines, a first electrode coupled to one of the data lines, and a second electrode coupled to a first node; a second transistor having a gate electrode coupled to a second node, a first electrode coupled to a first power source, and a second electrode coupled to the anode electrode of the OLED; a first capacitor coupled between the first node and the first electrode of the second transistor; a second capacitor coupled between the first node and the second node; a third transistor having a gate electrode coupled to one of the first control lines, a first electrode coupled to the gate electrode of the second transistor, and a second electrode coupled to the second electrode of the second transistor; a fourth transistor having a gate electrode coupled to the one of the first control lines, a first electrode coupled to the second electrode of the first transistor, and a second electrode coupled to a third power source; and a fifth transistor having a gate electrode coupled to one of the second control lines, a first electrode coupled to the second electrode of the second transistor, and a second electrode coupled to the anode electrode of the OLED, wherein the anode electrode of the OLED is coupled to the second electrode of the fifth transistor, and the cathode electrode of the OLED is coupled to a second power source.

The first to fifth transistors may be PMOS transistors.

The first control signal and the second control signal may be applied to the pixels at different times in accordance with the refresh rate of the input data.

The first power source and the third power source may have a voltage of a high level, and the second power source may have a voltage of a low level. The first power source and the third power source may be configured to apply voltage at the same levels.

### BRIEF DESCRIPTION OF THE DRAWINGS

The accompanying drawings illustrate exemplary embodiments of the present invention, and, together with the description, serve to explain principles of embodiments of the present invention.

FIG. 1 is a block diagram illustrating an organic light emitting display according to an embodiment of the present invention;

FIGS. 2A and 2B are views illustrating the driving operations of the organic light emitting display according to an embodiment of the present invention;

FIG. 3 is a circuit diagram illustrating the structure of an embodiment of the pixel illustrated in FIG. 1;

FIGS. 4A and 4B are driving timing diagrams of the pixel illustrated in FIG. 3.

### DETAILED DESCRIPTION

Hereinafter, certain exemplary embodiments according to the present invention will be described with reference to the accompanying drawings. Here, when a first element is described as being coupled to a second element, the first element may be directly coupled to the second element, or may be indirectly coupled to the second element via a third element. Further, some of the elements that are not essential to the complete understanding of the invention are omitted for clarity. Also, like reference numerals refer to like elements throughout.

Hereinafter, embodiments of the present invention will be described in detail with reference to the accompanying drawings.

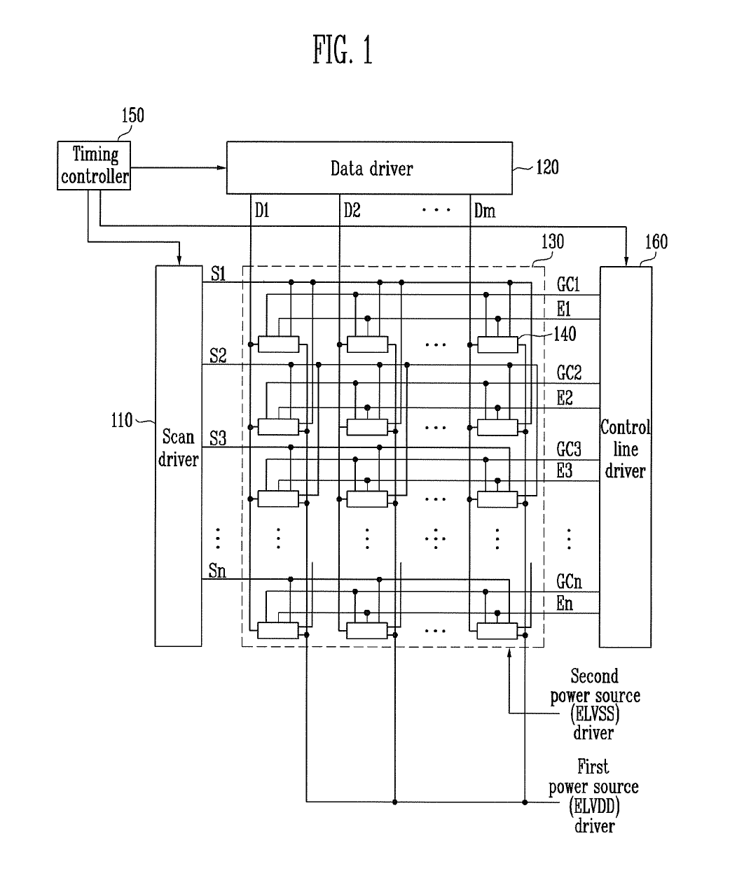

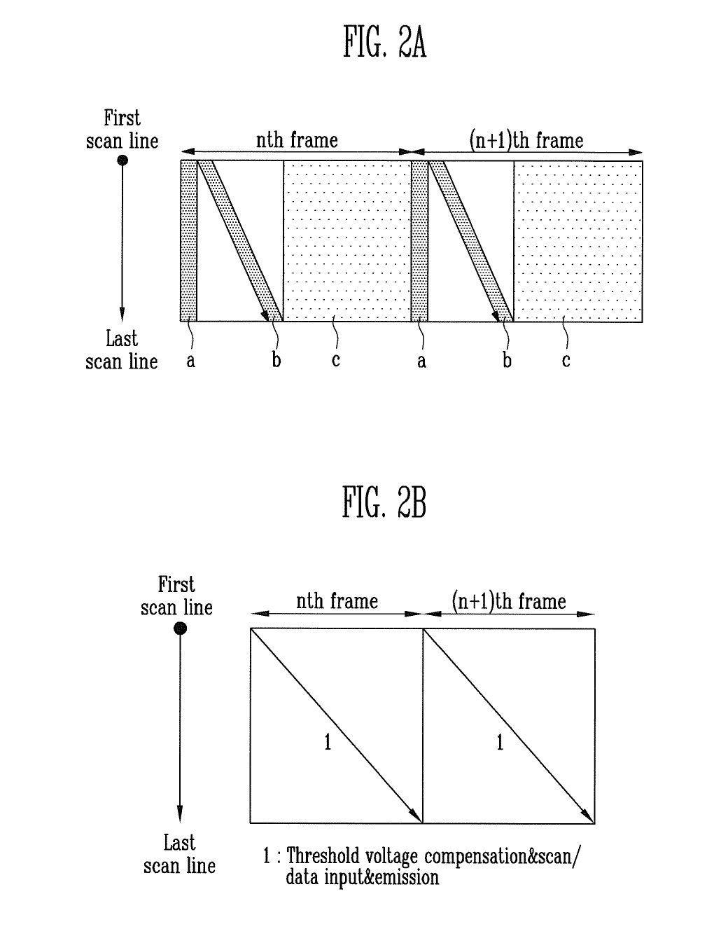

FIG. 1 is a block diagram illustrating an organic light emitting display according to an embodiment of the present invention. FIGS. 2A and 2B are views illustrating the driving operations of an organic light emitting display according to an embodiment of the present invention.

Referring to FIG. 1, an organic light emitting display according to an embodiment of the present invention includes: a display unit 130 including pixels 140 coupled to scan lines S1 to Sn; first control lines GC1 to GCn; second control lines E1 to En; data lines D1 to Dm; a scan driver 110 for providing scan signals to the pixels through the scan lines S1 to Sn; a control line driver 160 for providing first and second control signals to the pixels through the first control lines GC1 to GCn and the second control lines E1 to En; a data driver 120 for providing data signals to the pixels through the data lines D1 to Dm; and a timing controller 150 for controlling the scan driver 110, the data driver 120, and the control line driver 160.

In addition, the display unit 130 includes the pixels 140 positioned at crossing regions of the scan lines S1 to Sn and the data lines D1 to Dm. The pixels 140 receive a first power source ELVDD and a second power source ELVSS from outside of the display unit 130. The pixels 140 control the amount of current supplied from the first power source ELVDD to the second power source ELVSS via organic light emitting diodes (OLEDs) that emit light in accordance with data signals. The OLEDs generate light with brightness (e.g., a predetermined brightness) levels corresponding to the current flow through the OLEDs.

According to an embodiment of the present invention, a progressive emission method and a concurrent (e.g., simultaneous) emission method are selectively realized (or performed) according to a refresh rate of input data.

In the progressive emission method, data may be sequentially input to scan lines S1 to Sn in one frame and emission of light may be sequentially performed. In the concurrent (e.g., simultaneous) emission method, data may be sequentially input in a period of one frame and, after input of the data is completed, emission of light (or illumination) may be collectively (e.g., concurrently or simultaneously) performed on data of one frame throughout the entire display unit 130, that is, on all of the pixels 140 in the display unit 130.

The concurrent (e.g., simultaneous) emission method may be used for a three-dimensional (3D) display or a moving picture display of high picture quality having a high driving frequency (for example, 120 Hz), that is, having a high refresh rate.

For example, to view a shutter glasses type 3D display, a user looks at a screen wearing shutter glasses in which the transmittances of the left eye and the right eye are switched between 0% and 100%. The left eye image and the right eye image are alternately output from the display unit of an organic field emitting display onto a display screen in each of the frames so that the user looks at the left eye image only with the left eye and looks at the right eye image only with the right eye, such that a 3D effect is realized (or achieved).

For the shutter glasses type 3D display, when the left eye image and the right eye image are output onto the screen by a progressive emission method, a minimum response time (for example, 2.5 ms) of the shutter glasses is required. Emission of the left eye image should be fully turned off before emission of the right eye image, and the images should be switched within the response time period in order to prevent overlap of the left eye image and the right eye image in the user's vision (e.g., a cross talk phenomenon).

That is, an additional non-emission period may be generated between a frame (an nth frame) in which the left eye image is output and a frame (an (n+1)th frame) in which the right eye image is output, within the response time period, so that an emission time ratio (e.g., duty ratio) is reduced.

On the other hand, when driving is performed by the concurrent (e.g., simultaneous) emission method, the emission process of displaying an image may be concurrently (e.g., simultaneously) and collectively performed by the entire display unit. In periods other than the emission period, non-emission is performed so that the non-emission period between the period in which the left eye image is output and the period in which the right eye image is output can be easily performed (e.g., naturally secured). Therefore, unlike in the progressive emission method, it is not necessary to further reduce the emission time ratio (e.g., duty ratio).

However, the image displayed through the organic light emitting display according to an embodiment of the present invention is not necessarily limited to a 3D display having a high driving frequency (for example, 120 Hz), that is, having a high refresh rate or a moving picture of high picture quality. Displays on still screens such as screens for Internet browsing will also find increased use.

When an image having a low data refresh rate, that is, a low frequency (for example, 60 Hz or 30 Hz), for example a still image, is driven by a concurrent (e.g., simultaneous) driving method, it may not be efficient in terms of maintaining low power consumption and maximizing the life of an OLED.

According to an embodiment of the present invention, in driving an organic light emitting display, a progressive emission method or a concurrent (e.g., simultaneous) emission method may be selectively realized (or performed) in correspondence to a refresh rate of input data, so that high speed driving is performed when a high quality moving picture or a 3D image are displayed and so that power consumption may be reduced when a still image is displayed.

A concurrent (e.g., simultaneous) emission method and a progressive emission method according to an embodiment of the present invention will be described in detail with reference to FIGS. 2A and 2B.

First, referring to FIG. 2A, the concurrent (e.g., simultaneous) emission method may be divided into (a) a process of compensating for a threshold voltage, (b) a scanning process (e.g., a data inputting process), and (c) an emission process. The scanning process (e.g., data inputting process) (b) may be sequentially performed on the scan lines S1 to Sn. However, (a) the process of compensating for the threshold voltage and (c) the emission process may be concurrently (e.g., simultaneously) and collectively performed by the display unit 130 as illustrated in the drawing FIG. 2A.

In addition, before (a) the process of compensating for the threshold voltage, an initializing process and a resetting process may be further provided. In the initializing process, the voltages (or voltage levels) of the nodes of the pixel circuits provided in the pixels are initialized to be the same as when the threshold voltages of driving transistors are input. In the resetting process, the data voltages applied to the pixels 140 of the display unit 130 are reset and the voltage of the anode electrode of the OLED is reduced to no more than the voltage of the cathode electrode of the OLED so that the OLED does not emit light.

In addition, after emission is performed by the pixels during (c) the emission process, an emission off process of turning off emission for black insertion or dimming may be further provided.

When driving is performed by a concurrent (e.g., simultaneous) emission method, signals applied in (a) the process of compensating for the threshold voltage and (c) the emission process, for example, the scan signals applied to the scan lines S1 to Sn and control signals applied to the first control lines GC1 to GCn and the second control lines E1 to En, are concurrently (e.g., simultaneously) and collectively applied to the pixels 140 provided in the display unit 130 (e.g., applied at predetermined voltage levels).

The operations of the scan driver 110 and the control line driver 160 for outputting the signals may be controlled by the timing controller 150 as described above. For example, the points of time at which the signals are applied may be controlled by the timing controller 150.

Referring to FIG. 2B, in a progressive emission method, data are sequentially input to the scan lines S1 to Sn in one frame, and emission is sequentially performed while the data is being input. As illustrated in FIG. 2B, (a) the process of compensating for the threshold voltages of the driving transistors provided in the pixels is sequentially performed in one frame.

According to an embodiment of the present invention, a refresh rate of input data is determined in order to control the points of time (or timing) of application of the signals applied to the pixels so that driving can be performed by a concurrent (e.g., simultaneous) emission method as illustrated in FIG. 2A or by a progressive emission method as illustrated in FIG. 2B.

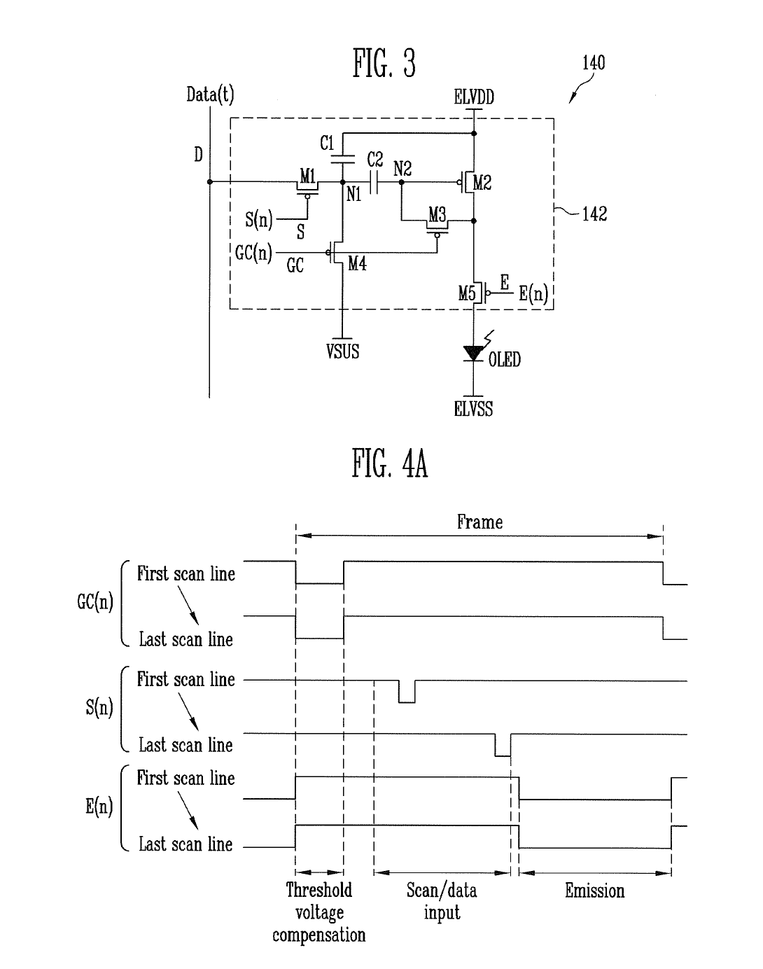

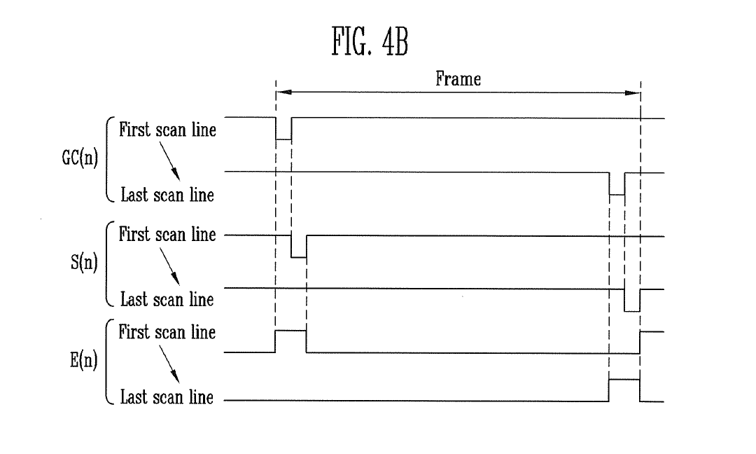

FIG. 3 is a circuit diagram illustrating the structure of an embodiment of the pixel illustrated in FIG. 1. FIGS. 4A and 4B are driving timing diagrams of the pixel illustrated in FIG. 3.

Referring to FIG. 3, a pixel 140 according to an embodiment of the present invention includes an OLED and a pixel circuit 142 for supplying current to the OLED.

The anode electrode of the OLED is coupled to the pixel circuit 142 and the cathode electrode of the OLED is coupled to a second power source ELVSS. The OLED generates light with a corresponding (or predetermined) brightness level in response to the current supplied from the pixel circuit 142.

The pixel circuit 142 provided in the pixel 140 includes five transistors M1 to M5 and two capacitors C1 and C2.

Here, the gate electrode of the first transistor M1 is coupled to a scan line S and the first electrode of the first transistor M1 is coupled to a data line D. The second electrode of the first transistor M1 is coupled to a first node N1.

Accordingly, a scan signal S(n) may be input to the gate electrode of the first transistor M1 and a data signal Data(t) may be input to the first electrode of the first transistor M1.

In one embodiment, the gate electrode of the second transistor M2 is coupled to a second node N2, the first electrode of the second transistor M2 is coupled to a first power source ELVDD having a high level voltage value, and the second electrode of the second transistor M2 is coupled to the anode electrode of the OLED. The second transistor M2 may function as a driving transistor. The second electrode of the second transistor M2 is coupled to the anode electrode of the OLED via the fifth transistor M5 as illustrated in FIG. 3.

The first capacitor C1 is coupled between the first node N1 and the first electrode of the second transistor M2, which is coupled to the first power source ELVDD. The second capacitor C2 is coupled between the first node N1 and the second node N2.

In addition, the gate electrode of the third transistor M3 is coupled to the first control line GC, the first electrode of the third transistor M3 is coupled to the gate electrode of the second transistor M2, and the second electrode of the third transistor M3 is coupled to the anode electrode of the OLED, and to the second electrode of the second transistor M2.

Therefore, the first control signal GC(n) may be input to the gate electrode of the third transistor M3 and, when the third transistor M3 is turned on, the second transistor M2 is diode-coupled.

In addition, the gate electrode of the fourth transistor M4 is coupled to the first control line GC, the first electrode of the fourth transistor M4 is coupled to the first node N1, and to the second electrode of the first transistor M1, and the second electrode of the fourth transistor M4 is coupled to a third power source VSUS. The third power source VSUS may have a high level voltage value and may be realized by (or set at) the same voltage value as the first power source ELVDD.

According to an embodiment of the present invention, a first control signal GC(n) applied to a first control line GC is applied to the pixels at different timings depending on whether driving is performed by the concurrent (e.g., simultaneous) emission method or by the progressive emission method.

When driving is performed by the concurrent (e.g., simultaneous) emission method, as illustrated in FIG. 2A, the first control signal GC(n) is concurrently (e.g., simultaneously) and collectively provided to the pixels 140 included in the display unit 130 during (a) the process of compensating for the threshold voltages in one frame. When driving is performed by the progressive emission method as illustrated in FIG. 2B, the first control signal GC(n) is sequentially provided to the pixels 140 in one frame.

Further, when driving is performed by the progressive emission method, the first control signal may be applied with the same waveform as a previous scan signal S(n−1) relative to (or in comparison with) the scan signal S(n) applied to a specific scan line (an nth scan line).

In addition, in one embodiment the gate electrode of the fifth transistor M5 is coupled to a second control line E, the first electrode of the fifth transistor M5 is coupled to the second electrode of the second transistor M2, and the second electrode of the fifth transistor M5 is coupled to the anode electrode of the OLED.

According to an embodiment of the present invention, a second control signal E(n) applied to the second control line E as a signal for controlling emission time may be applied to the pixels at different timings when driving is performed by the concurrent (e.g., simultaneous) emission method and when driving is performed by the progressive emission method.

That is, when driving is performed by the concurrent (e.g., simultaneous) emission method, as illustrated in FIG. 2A, the second control signal E(n) may be concurrently (e.g., simultaneously) and collectively provided to the pixels 140 provided in the display unit 130 during (c) the emission process in one frame. However, when driving is performed by the progressive emission method as illustrated in FIG. 2B, the second control signal E(n) may be sequentially provided to the pixels in one frame.

In addition, the cathode electrode of the OLED is coupled to a second power source ELVSS, which has a low level voltage value.

According to the embodiment illustrated in FIG. 3, the first to fifth transistors M1 to M5 may be p-channel metal-oxide-semiconductor field-effect transistors (PMOSs).

As described above, according to an embodiment of the present invention, data input through the timing controller determines a refresh rate. When the input data is a 3D image having a high refresh rate or a moving picture with high picture quality, driving may be performed by the concurrent (e.g., simultaneous) emission method. When the input data has a low refresh rate, for example, a still image, driving may be performed by the progressive emission method.

FIG. 4A is a driving timing diagram of realizing (or performing) the concurrent (e.g., simultaneous) emission method to drive the pixel illustrated in FIG. 3 according to one embodiment of the present invention. FIG. 4B is a driving timing diagram of realizing (or performing) the progressive emission method to drive the pixel illustrated in FIG. 3.

When the concurrent (e.g., simultaneous) emission method is described with reference to FIGS. 3 and 4A, the operation periods that constitute one frame are temporally separated. According to an embodiment of the present invention, the operation periods that constitute each of the frames are separated into (a) a threshold voltage compensating period, (b) a scanning/data inputting period, and (c) an emission period.

As described above, before (a) the threshold voltage compensating period, an initializing period and a resetting period may be further provided and, after (c) the emission period, an emission off period may be further provided.

During (a) the threshold voltage compensating period, a second capacitor C2 stores a threshold voltage Vth of the driving transistor M2 provided in each of the pixels 140 of the display unit 130. Storing the threshold voltage Vth in the second capacitor C2 can remove defects caused by variations in the threshold voltage Vth of the driving transistor M2 when a data voltage is charged in each of the pixels.

In (a) the threshold voltage compensating section, as illustrated in FIG. 4A, the first control signal GC(n) may be applied at a low level so that the third transistor M3 and the fourth transistor M4 are turned on, and the scan signal S(n) and the second control signal E(n) may be applied at a high level.

The gate electrode of the second transistor M2 and the second electrode of the third transistor M3 are electrically coupled at a second node N2 so that, as a result, the second transistor M2 is diode-coupled and the voltage at the first node N1 becomes that of a third power source VSUS.

Therefore, the voltage corresponding to the threshold voltage Vth of the second transistor M2 may be stored in the second capacitor C2 coupled to the first node N1 and the second node N2. The voltage stored in the second capacitor C2 offsets variations in the threshold voltage Vth of the driving transistor (e.g., the second transistor M2) generated during (b) the scanning section (e.g., data inputting section) so that, in the current finally applied to the OLED, components corresponding to defects caused by the variation in the threshold voltage of the driving transistor are removed.

In addition, since (a) the threshold voltage compensating process is collectively applied to the pixels 140 that constitute the display unit 130, the signals applied during (a) the threshold voltage compensating process, for example, the first control signal GC(n), the scan signal S(n), and the second control signal E(n), are concurrently (e.g., simultaneously) applied to all of the pixels 140 with the voltage values at set levels.

After (a) the threshold voltage compensating period, in (b) the scanning/data inputting period, low level scan signals may be sequentially input to the scan lines S1 to Sn, and data signals may be sequentially input to the data lines of the pixels coupled to the scan lines S1 to Sn.

In (b) the scanning/data inputting period, as illustrated in FIG. 4A, the first control signal GC(n) and the second control signal E(n) may be applied at a high level so that the third transistor M3, the fourth transistor M4, and the fifth transistor M5 are turned off.

Therefore, during (b) the scanning/data inputting period, the scan signals and the data signals may be applied by the same method as in the progressive driving method.

In (b) the scanning/data inputting period, since the second control signal E(n) is applied at a high level, the fifth transistor M5 is turned off so that a current path is not formed between the OLED and the first power source ELVDD and the current does not actually flow to the OLED. That is, emission is not performed.

Then, in (c) the emission period, the current corresponding to the data voltage stored in each of the pixels 140 of the display unit 130 is provided to an OLED included in each of the pixels so that emission is performed. In (c) the emission period, unlike in the previous (b) scanning/data inputting period, the second control signal E(n) may be applied at a low level so that the fifth transistor M5 is turned on and a current path from the first power source ELVDD to the cathode electrode of the OLED is formed.

Therefore, the current corresponding to the Vgs voltage value of the second transistor M2, that is, a voltage difference Vgs between the gate electrode of the second transistor and the first electrode of the second transistor M2, is applied to the OLED, and light is emitted at a brightness level corresponding to the amount of current flow.

According to one embodiment, since (c) the emission process is collectively applied to the pixels 140 that constitute the display unit 130, the signals applied in the emission process, for example, the first control signal GC(n), the scan signal S(n), and the second control signal E(n), are concurrently (e.g., simultaneously) applied to all of the pixels 140 with the voltage values at set levels.

The driving method of a progressive emission method according to one embodiment is described with reference to FIGS. 3 and 4B. As illustrated in FIG. 4B, operations corresponding to ((a) the threshold voltage compensating period, (b) the scanning/data inputting period, and (c) the emission period) that constitute one frame are sequentially performed on the scan lines S1 to Sn.

That is, the pixels coupled to the scan lines S1 to Sn perform operations of compensating for the threshold voltage Vth of the driving transistor M2 provided in the pixels 140. In this embodiment, data are sequentially input and emission is sequentially performed.

Since (a) the threshold voltage compensating operation, (b) the scanning/data inputting operation, and (c) the emission operation are performed according to substantially the same principles as described above with reference to FIG. 4A, repeated description of substantially the same operations will be omitted.

In the progressive emission method illustrated in FIG. 4B, unlike in the concurrent (e.g., simultaneous) emission method of FIG. 4A, there is no period in which the first control signals GC(n), the scan signals S(n), and/or the second control signals E(n) are simultaneously applied to all of the pixels 140 with the voltage values at set levels.

Therefore, the first control signal GC(n) and the second control signal E(n) applied to the first control line GC and the second control line E, respectively, are applied to the pixels at different timings when driving is performed by a concurrent (e.g., simultaneous) emission method and when driving is performed by a progressive emission method.

For example, when the progressive driving method according to an embodiment of the present invention is applied, the first control signal GC(n) may be applied to the first control line GC with the same waveform as the previous scan signal S(n−1) relative to (or in comparison with) the scan signal S(n) applied to a specific scan line (nth scan line) as illustrated in FIG. 4B.

In addition, after the scan signal S(n) is applied to the scan lines S1 to Sn, the second control signal E(n) applied to the second control line E may be applied at a low level for the remainder of the frame.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display comprising:
a display unit comprising a plurality of pixels coupled to scan lines, first control lines, second control lines, and data lines;
a control line driver for providing first and second control signals to the pixels through the first and second control lines; and
a timing controller for controlling the control line driver,
wherein the timing controller is configured to determine a refresh rate of input data to control points of time at which the first and second control signals are applied in a frame.

2. The organic light emitting display as claimed in claim 1, wherein, when data with a high refresh rate are input, the frame is temporally separated into a plurality of operation periods.

3. The organic light emitting display as claimed in claim 2, wherein the first and second control signals are concurrently provided to the pixels in a first period of the frame.

4. The organic light emitting display as claimed in claim 1, wherein, when data with a low refresh rate are input, a plurality of operation periods are sequentially performed in the scan lines in the frame.

5. The organic light emitting display as claimed in claim 4, wherein the first and second control signals are sequentially provided to the pixels in the frame.

6. The organic light emitting display as claimed in claim 1, wherein each of the pixels comprises:
an organic light emitting diode (OLED) having an anode electrode and a cathode electrode;
a first transistor having a gate electrode coupled to one of the scan lines, a first electrode coupled to one of the data lines, and a second electrode coupled to a first node;
a second transistor having a gate electrode coupled to a second node, a first electrode coupled to a first power source, and a second electrode coupled to the anode electrode of the OLED;
a first capacitor coupled between the first node and the first electrode of the second transistor;
a second capacitor coupled between the first node and the second node;
a third transistor having a gate electrode coupled to one of the first control lines, a first electrode coupled to the gate electrode of the second transistor, and a second electrode coupled to the second electrode of the second transistor;
a fourth transistor having a gate electrode coupled to the one of the first control lines, a first electrode coupled to the second electrode of the first transistor, and a second electrode coupled to a third power source; and
a fifth transistor having a gate electrode coupled to one of the second control lines, a first electrode coupled to the second electrode of the second transistor, and a second electrode coupled to the anode electrode of the OLED, wherein
the anode electrode of the OLED is coupled to the second electrode of the fifth transistor, and the cathode electrode of the OLED is coupled to a second power source.

7. The organic light emitting display as claimed in claim 6, wherein the first to fifth transistors are PMOS transistors.

8. The organic light emitting display as claimed in claim 6, wherein the first control signal and the second control signal are applied to the pixels at different times in accordance with the refresh rate of the input data.

9. The organic light emitting display as claimed in claim 6,
wherein the first power source and the third power source have a voltage of a high level, and
wherein the second power source has a voltage of a low level.

10. The organic light emitting display as claimed in claim 9, wherein the first power source and the third power source are configured to apply voltage at the same levels.
